(19) United States
(12) Patent Application Publication
(10) Pub. No.: US 2015/0077345 A1
(43) Pub. Date: Mar. 19, 2015

(54) Simultaneous Hover and Touch Interface

(71) Applicant: Microsoft Corporation, Redmond, WA (US)

(72) Inventors: Dan Hwang, New Castle, WA (US); Lynn Dai, Samamish, WA (US)

(73) Assignee: Microsoft Corporation, Redmond, WA (US)

(21) Appl. No.: 14/027,288

(22) Filed: Sep. 16, 2013

(51) Int. Cl. G06F 3/041

(52) U.S. Cl. CPC G06F 3/0416; G06F 3/0412
USPC 345/173

(57) ABSTRACT

Example apparatus and methods concern processing simultaneous touch and hover actions for a touch-sensitive and hover-sensitive input/output (i/o) interface. One example apparatus includes a touch detector that detects an object that touches the i/o interface. The example apparatus includes a proximity detector that detects an object in a hover-space associated with the i/o interface. The apparatus produces characterization data concerning the touch action and the hover action. The proximity detector and the touch detector may share a set of capacitive sensing nodes. Example apparatus and methods selectively control input/output actions on the i/o interface based on a combination of the touch action(s) and the hover action(s).

### BACKGROUND

Touch sensitive screens have, in some apparatus, been replaced by hover-sensitive screens that rely on proximity detectors. While touch sensitive screens detected objects that touched the screen, hover-sensitive screens may detect objects that are “hovering” within a certain distance of the screen. A touch sensitive screen may have identified the points on the screen that were being touched by the user, by a user stylus or pen, or other object. Actions could be controlled based on the touch points and the actions that occurred at the touch points. Conventional hover-sensitive screens detect objects in a hover-space associated with the hover-sensitive device.

Conventionally, a screen may have been either a touch-sensitive screen or a hover-sensitive screen. Thus, hover interactions and touch interactions have been considered separate tasks that a user performs at separate times (e.g., sequentially) but not at the same time. In some conventional systems, a user may have had to choose between touch interactions or hover interactions. This may have needlessly limited the potential richness of input actions.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed towards accepting inputs involving simultaneous or coordinated touch and hover actions. For example, a user may be able to perform an input action that includes both a hover and a touch action. The touch may begin the action and be supplemented by the hover or the hover may begin the action and be supplemented by the touch. Being able to use hover and touch at the same time introduces a new way to interact with screens that are both touch and hover sensitive.

Some embodiments may include a capacitive input/output (i/o) interface that is sensitive to both touch and hover actions. The capacitive i/o interface may detect objects (e.g., finger, thumb, stylus) that touch the screen. The capacitive i/o interface may also detects objects (e.g., finger, thumb, stylus) that are not touching the screen but that are located in a three dimensional volume (e.g., hover-space) associated with the screen. The capacitive i/o interface may be able to simultaneously detect a touch action and a hover action. The capacitive i/o interface may be able to detect multiple simultaneous touch actions and multiple simultaneous hover actions. An embodiment may produce characterization data concerning the touch action(s) and the simultaneous hover action(s). An embodiment may selectively control the action performed on the i/o interface as a function of the characterization data.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example touch and hover-sensitive device.

FIG. 2 illustrates an example touch and hover-sensitive device.

FIG. 3 illustrates a portion of an example touch and hover-sensitive device.

FIG. 4 illustrates a portion of an example touch and hover-sensitive device.

FIG. 5 illustrates an example method associated with a simultaneous hover and touch interface.

FIG. 6 illustrates an example method associated with a simultaneous hover and touch interface.

FIG. 7 illustrates an example cloud operating environment in which a simultaneous hover and touch interface may operate.

FIG. 8 is a system diagram depicting an exemplary mobile communication device configured with a simultaneous hover and touch interface.

FIG. 9 illustrates an example apparatus that provides a simultaneous hover and touch interface.

### DETAILED DESCRIPTION

Example apparatus and methods detect touch actions performed by objects that touch an i/o interface. Example apparatus and methods also detect hover actions performed by objects in a hover-space associated with an i/o interface. Example apparatus and methods then determine how, if at all, to combine the touch actions with the hover actions. Once the combination of touch actions and hover actions is determined, i/o performed by the i/o interface will be controlled, at least in part, by the combination.

Touch technology is used to detect an object that touches a touch-sensitive screen. “Touch technology” and “touch sensitive” refer to sensing an object that touches the i/o interface. The i/o interface may be, for example, a capacitive interface. The capacitance sensed by a capacitive sensor may be affected by the different dielectric properties and effects on capacitance of an object that touches a screen. For example, the dielectric properties of a finger are different than the dielectric properties of air. Similarly, the dielectric properties of a stylus are different than the dielectric properties of air. Thus, when either the finger or stylus touches the capacitive i/o interface, the change in capacitance can be sensed and used to identify an input action. While a capacitive i/o interface is described, more generally a touch sensitive i/o interface may be employed.

Hover technology is used to detect an object in a hover-space. “Hover technology” and “hover sensitive” refer to sensing an object spaced away from (e.g., not touching) yet in close proximity to a display in an electronic device. “Close proximity” may mean, for example, beyond 1 mm but within 1 cm, beyond 0.1 mm but within 10 cm, or other combinations of ranges. Being in close proximity includes being within a range where a proximity detector (e.g., capacitive sensor) can detect and characterize an object in the hover-space. The device may be, for example, a phone, a tablet computer, a computer, or other device. Hover technology may depend on a proximity detector(s) associated with the device that is hover sensitive. Example apparatus may include the proximity detector(s).

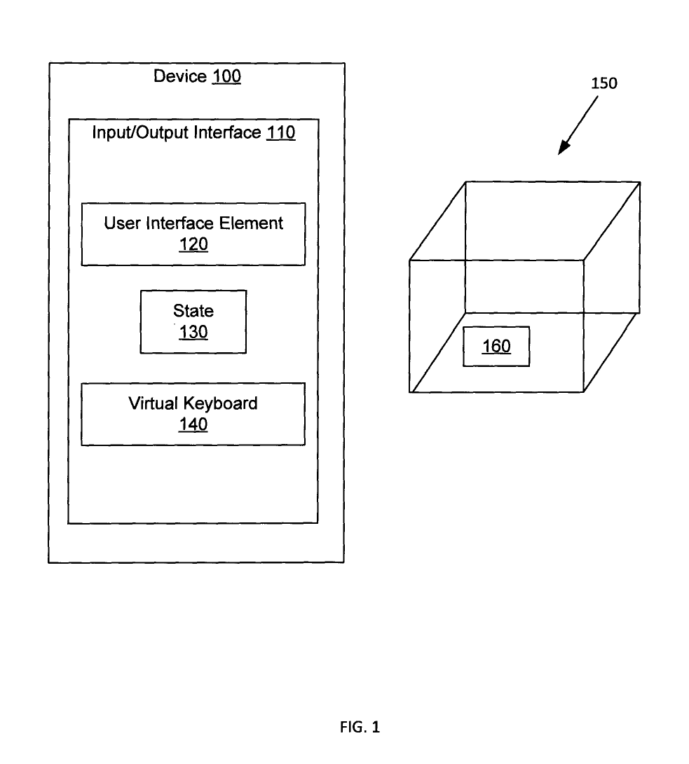

FIG. 1 illustrates an example device 100 that is both touch-sensitive and hover-sensitive. Device 100 includes an input/output (i/o) interface 110. I/O interface 100 is both touch-sensitive and hover-sensitive. I/O interface 100 may display a set of items including, for example, a virtual keyboard 140 and, more generically, a user interface element 120. User interface elements may be used to display information and to receive user interactions. Conventionally, user interactions were performed either by touching the i/o interface 110 or by hovering in the hover-space 150. Example apparatus facilitate identifying and responding to input actions that use both touch actions and hover actions.

Device 100 or i/o interface 110 may store state 130 about the user interface element 120, the virtual keyboard 140, or other items that are displayed. The state 130 of the user interface element 120 may depend on the order in which touch and hover actions occur, the number of touch and hover actions, whether the touch and hover actions are static or dynamic, whether the combined hover and touch actions describe a gesture, or on other properties of the touch and hover actions. The state 130 may include, for example, the location of a touch action, the location of a hover action, a gesture associated with the touch action, a gesture associated with the hover action, or other information.

The device 100 may include a touch detector that detects when an object (e.g., digit, pencil stylus with capacitive tip) is touching the i/o interface 110. The touch detector may report on the location (x, y) of an object that touches the i/o interface 110. The touch detector may also report on a direction in which the object is moving, a velocity at which the object is moving, whether the object performed a tap, double tap, triple tap or other tap action, whether the object performed a recognizable gesture, or other information.

The device 100 may also include a proximity detector that detects when an object (e.g., digit, pencil, stylus with capacitive tip) is close to but not touching the i/o interface 110. The proximity detector may identify the location (x, y, z) of an object 160 in the three-dimensional hover-space 150. The proximity detector may also identify other attributes of the object 160 including, for example, the speed with which the object 160 is moving in the hover-space 150, the orientation (e.g., pitch, roll, yaw) of the object 160 with respect to the hover-space 150, the direction in which the object 160 is moving with respect to the hover-space 150 or device 100, a gesture being made by the object 160, or other attributes of the object 160. While a single object 160 is illustrated, the proximity detector may detect more than one object in the hover-space 150.

In different examples, the touch detector may use active or passive systems. Similarly, in different examples, the proximity detector may use active or passive systems. In one embodiment, a single apparatus may perform both the touch detector and proximity detector functions. The combined detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the combined detector uses capacitive technology, the detector may include a set of capacitive sensing nodes to detect a capacitance change in the hover-space 150 or on the i/o interface 110. The capacitance change may be caused, for example, by a digit(s) (e.g., finger, thumb) or other object(s) (e.g., pen, capacitive stylus) that touch the capacitive sensing nodes or that come within the detection range of the capacitive sensing nodes.

In general, a proximity detector includes a set of proximity sensors that generate a set of sensing fields on the i/o interface 110 and in the hover-space 150 associated with the i/o interface 110. The touch detector generates a signal when an object touches the i/o interface 110 and the proximity detector generates a signal when an object is detected in the hover-space 150. In one embodiment, a single detector may be employed for both touch detection and proximity detection, and thus a single signal may report a combined touch and hover event.

In one embodiment, characterizing a touch includes receiving a signal from a touch detection system (e.g., touch detector) provided by the device. The touch detection system may be an active detection system (e.g., infrared, ultrasonic), a passive detection system (e.g., capacitive), or a combination of systems. Characterizing a hover may also include receiving a signal from a hover detection system (e.g., hover detector) provided by the device. The hover detection system may also be an active detection system (e.g., infrared, ultrasonic), a passive detection system (e.g., capacitive), or a combination of systems. Characterizing a combined touch and hover event may also include receiving a signal from an active detection system or a passive detection system incorporated into the device. The signal may be, for example, a voltage, a current, an interrupt, a computer signal, an electronic signal, or other tangible signal through which a detector can provide information about an event the detector detected. In one embodiment, the touch detection system and the hover detection system may be the same system. In one embodiment, the touch detection system and the hover detection system may be incorporated into the device or provided by the device.

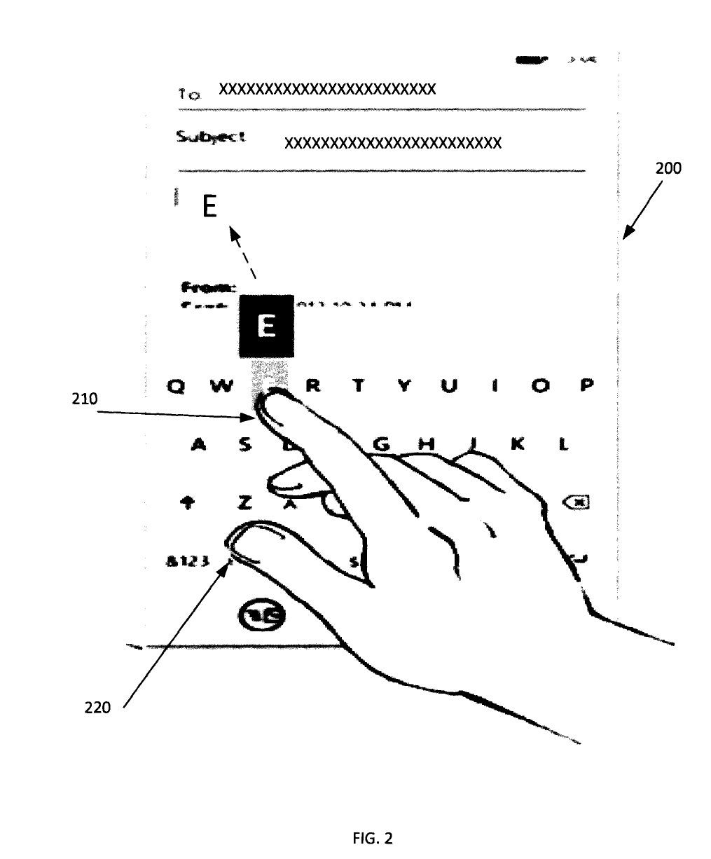

FIG. 2 illustrates a simulated touch-sensitive and hover-sensitive device 200 where one digit is performing a touch action while another digit is performing a hover action. Since the touch action and the hover action are being performed at the same time, device 200 may interpret the two actions as a single combined action. By way of illustration, hovering finger 210 over a certain key on a virtual keyboard may cause that key to become highlighted. Then, making another hover action (e.g., simulated typing action) over the highlighted key may cause an input action that causes a certain keystroke to appear in a text input box. For example, the letter e or E may be placed in a text input box. But there are two choices for the letter, either lower case e or upper case E. The typing experience on a touch or hover sensitive device can be impacted by the ease or difficulty with which upper and lower case letters can be chosen.

In FIG. 2, thumb 220 is illustrated touching device 200. Thumb 220 may be touching a user interface element (e.g., virtual shift key) that controls whether a letter entered in response to a hover action by finger 210 is a lower case e or an upper case E. In FIG. 2, thumb 200 has performed a touch action that causes an upper case E to be produced by the hover action. Conventionally, a user may have had to perform a hover action over a shift key, then had to move their finger to the desired letter, then had to enter the letter. The user may have had to hover over the shift key for each keystroke that was intended to be entered as a capital letter. Device 200 provides more flexibility by combining simultaneous touch and hover actions. In one example, device 200 facilitates performing a touch and hold action on the shift key with thumb 220 and then entering as many upper case letters as desired with finger 210. When the user wants to return to lower case typing the user would simply lift thumb 220 from the screen without having to relocate hovering finger 210.

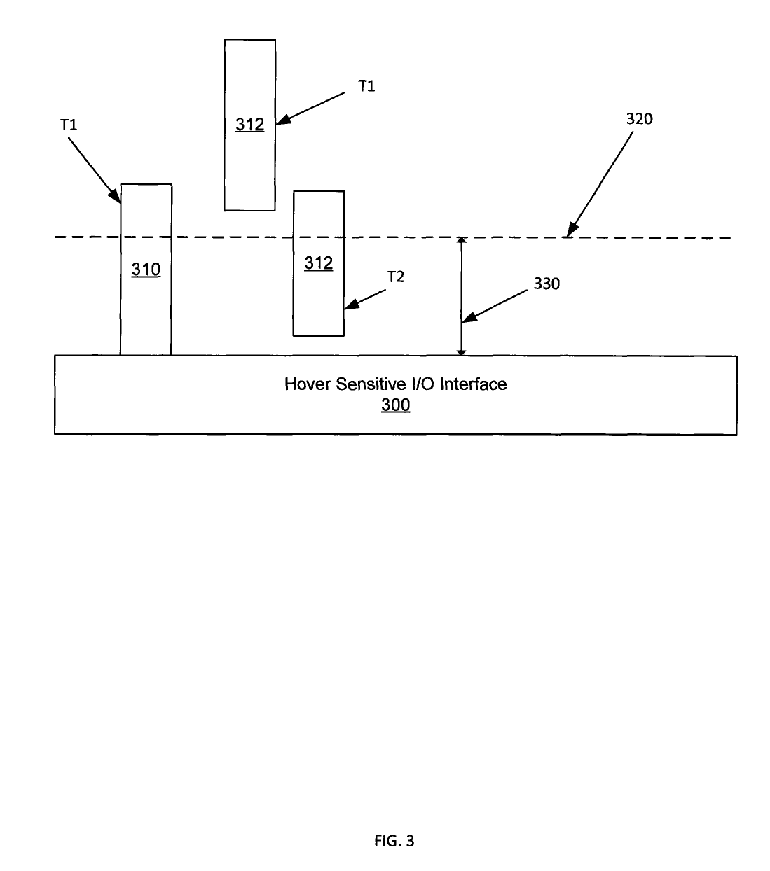

FIG. 3 illustrates a touch-sensitive and hover sensitive i/o interface 300. Line 320 represents the outer limit of the hover-space associated with hover sensitive i/o interface 300. Line 320 is positioned at a distance 330 from i/o interface 300. Distance 330 and thus line 320 may have different dimensions and positions for different apparatus depending, for example, on the proximity detection technology used by a device that supports i/o interface 300.

Example apparatus and methods may identify objects located in the hover-space bounded by i/o interface 300 and line 320. Example apparatus and methods may also identify objects that are touching the i/o interface 300. For example, device 300 may detect object 310 when it touches i/o interface 300 at time T1. Since object 312 is neither touching i/o interface 310 nor in the hover zone for i/o interface 300, object 312 may not be detected at time T1. But at time T2, object 312 may enter the hover space and be detected. I/O interface 300 may be configured to determine whether to treat the touch action that occurred at time T1 and the hover action that occurred at time T2 as separate actions or as a combined action. The determination may depend on the amount of time that elapsed between time T1 and time T2, the user interface elements associated with the touch action for object 310 and the hover action for object 312, or as a function of other information.

By way of illustration of the time component, if the touch and hover action occur within a pre-determined threshold of time, then the actions may be considered to be a combined touch and hover action. But if the touch and hover actions are separated by more than the threshold amount of time, then they may be considered to be separate actions. The threshold amount of time may be, for example, less than 0.01 of a second, less than 0.1 of a second, less than 0.5 of a second, less than a second, or other time periods. In one embodiment, different time thresholds may be used. In one embodiment, the threshold amount of time may be configurable.

By way of illustration of the user interface component, if the touch action is associated with a certain user interface element (e.g., shift key), then the amount of time that elapses between touching the shift key and a hover action to enter a keystroke may be irrelevant. While a shift key is described, a touch and hover combination may be used in different applications. Consider a video game where a touch action may be used to select a character or vehicle (e.g., helicopter) to move and a hover action may be used to indicate the direction and velocity to move the character or vehicle. If the user hovers their finger close to the screen then the character may move more quickly than if the user hovers their finger farther from the screen. In another video game, a hover action may be used to select a weapon to fire. For example, a user may hover over a machine gun to select the weapon and then may tap on the screen where the machine gun is supposed to be aimed. In another video game, an ordered pair of touch actions may be used to select a starting point and an end point and a subsequent hover action may be used to indicate speed or intensity. For example a first touch with one finger may indicate the origin of flames from a flamethrower, a second touch with the same finger may indicate the direction in which the flames are supposed to be sent, and a hover action with a separate finger, pen, or stylus may indicate the intensity of the flames. The intensity may be varied by moving the hovering object (e.g., digit, stylus) closer to or further from the screen. While typing and video games are described, other combinations of combined touch and hover actions may be performed.

Different users may have different desires concerning how simultaneous touch and hover actions should be handled. Thus, in one embodiment, example apparatus and methods may provide an application programming interface (API) through which a user, program, process, or other actor may configure or reconfigure i/o interface 300. Thus, one user may want touch to be primary and hover to be secondary, another user may want hover to be primary and touch to be secondary, and another user may want there to be no primary/secondary ordering. Additionally, a user may want different ordering, gestures, or threshold times for different applications or at different times. The configuration may also identify combinations of different touch and hover actions to be identified and handled. The configuration may also provide information for handling a touch and hover action. For example, the configuration may include a callback address, socket, service, process, or other entity that may participate in handling the action and controlling a user interface element in response to the combined action. In one embodiment, the configuration may be performed using logic in the device supporting i/o interface 300 while in another embodiment the configuration may be performed off the device.

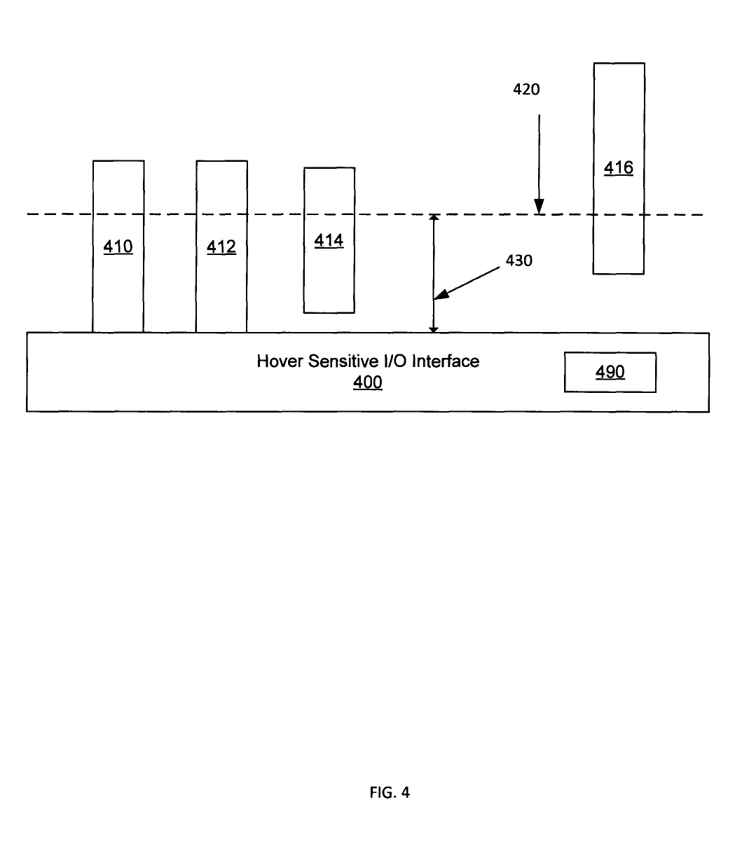

FIG. 4 illustrates a touch and hover sensitive i/o interface 400. Line 420 depicts the limits of a hover-space associated with i/o interface 400. Line 420 is positioned at a distance 430 from the i/o interface 400. The hover-space may be present between the i/o interface 400 and line 420. While a straight line is illustrated, the hover-space may vary in size and shape.

FIG. 4 illustrates object 410 touching the i/o interface 400 and object 412 touching the i/o interface 400. Additionally, FIG. 4 illustrates object 414 hovering in the hover space and object 416 hovering in the hover space. Object 416 may be hovering over a particular user interface element 490 displayed on the i/o interface 400. While some touch and hover actions may involve first touching the i/o interface 400 and then performing a hover action (e.g., typing), some touch and hover actions may involve first hovering over user interface element 490 and then performing additional touch or hover actions. Since i/o interface 400 can detect multiple touch events and multiple hover events, and the order in which the events occur, and the combinations of events, a rich set of user interface interactions are possible. For example, object 416 may hover over user interface element 490 to select a color to be used in a painting application. User interface element 490 may be a palette where both discrete colors and blended colors that form transitions between discrete colors are available. The distance at which object 416 hovers above element 490 may control whether a single color is selected or whether a combination of colors are selected. Objects 410 and 412 may identify a line to be painted with the color selected by object 416. Object 414 may control the thickness of the line. For example, hovering object 414 closer to the i/o interface 400 may produce a thinner line while hovering object 414 farther away from the i/o interface 400 may produce a thicker line.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

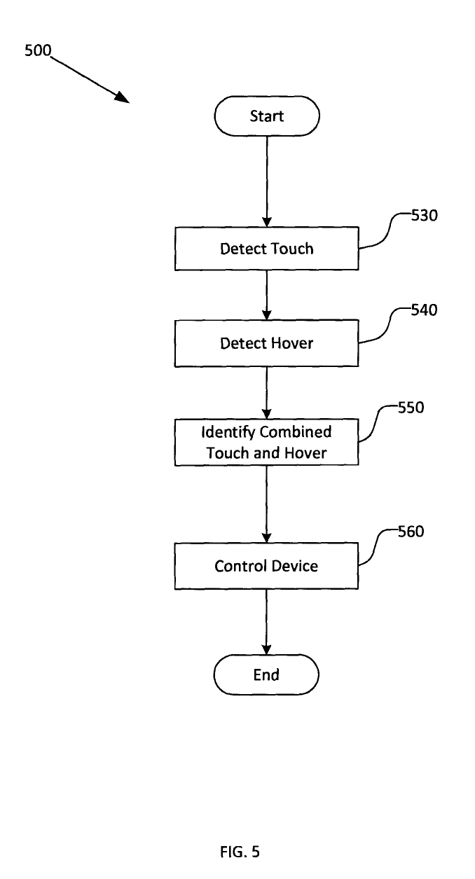

FIG. 5 illustrates an example method 500 associated with a simultaneous touch and hover interface. Method 500 includes, at 530, detecting a touch interaction with the input/output interface. Method 500 may also include, at 540, detecting a hover interaction with the input/output interface. The touch interaction and the hover interaction are related and operate at least partially simultaneously and therefore can be detected simultaneously as discrete events or as a combined event.

In one embodiment, detecting the touch interaction at 530 involves receiving a first signal from a detector and detecting the hover interaction at 540 involves receiving a second signal from the detector. This is detecting the events as simultaneous discrete events. The detector may include, for example, a set of capacitive nodes. While two separate signals are described, one associated with detecting a touch and one associated with detecting a hover, in one embodiment, detecting the touch interaction and detecting the hover interaction may include receiving a single signal from a detector. This is detecting the events as a combined event. The single signal may provide information about a combined touch and hover event rather than receiving separate signals about separate touch and hover events.

In one embodiment, both the touch interaction and the hover interaction may be performed by the same object. For example a user may hover a digit over a user interface element to select the element, may touch a portion of the element to select a particular feature provided by the user interface element, and may then hover to control an aspect of the feature provided. In another embodiment, the touch interaction and the hover interaction may be performed by two separate objects. For example a user may use a stylus with a capacitive tip to select an item and may use a digit to control an action performed by the selected item.

Method 500 may also include, at 550, identifying a combined touch and hover interaction associated with the touch interaction and the hover interaction. The combined touch and hover interaction may depend on one or more touches that occur at least partially in parallel (e.g., partially simultaneously, partially concurrently) with one or more hover interactions. In one embodiment, the touch interaction may include two or more touch interactions that occur serially or at least partially in parallel. For example, a user may touch an i/o interface at a first location to identify a starting location for a video game effect (e.g., flames) and may touch the i/o interface at a second location to identify an ending location for the effect. Additionally, a hover interaction may include two or more hover interactions that occur serially or at least partially in parallel. For example, a user may hover a first digit over a first location and at a first height to indicate an intensity associated with producing a sound from a virtual violin string and may hover a second digit over a second location and at a second height to indicate an effect (e.g., reverb) associated with the sound produced by the virtual violin string.

Method 500 may also include, at 560, selectively controlling the device as a function of the combined touch and hover interaction. In one embodiment, selectively controlling the device as a function of the combined touch and hover interaction includes providing an input signal from the input/output interface. For example, the combined touch and hover interaction may identify a character to be entered into a text box, a graphic to be added to a drawing, a brush stroke to be used to build a Kanji character, or other input. In one embodiment, selectively controlling the device as a function of the combined touch and hover interaction includes providing an output signal to the input/output interface. For example, the combined touch and hover interaction may identify a brush stroke location, width, color, and intensity to be displayed in a virtual painting program. Similarly, the combined touch and hover interaction may identify a desired note, volume, and reverberation to be played by a virtual musical instrument.

More generally, a touch interaction may control a first attribute of a user interface element and a hover interaction may control a second different attribute of the user interface element. The combined touch and hover interaction may coordinate controlling the first attribute and the second attribute simultaneously. The first attribute may be a choice of a user interface element to display and the second attribute may be a property of the user interface element.

Method 500 may be used by different applications in different ways. Thus, selectively controlling the device as a function of the combined touch and hover interaction may include controlling a typing application, controlling a video game, controlling a virtual painting application, controlling a virtual musical instrument, or controlling other applications.

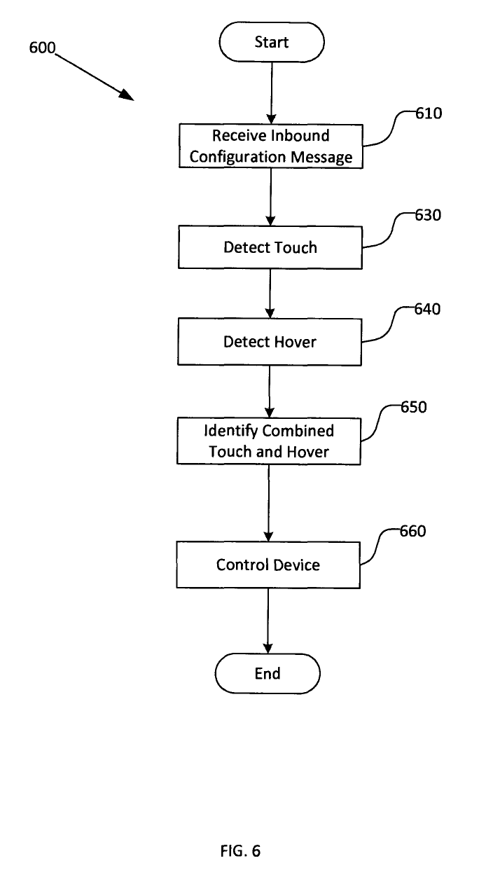

FIG. 6 illustrates an example method 600 that is similar to method 500 (FIG. 5). For example, method 600 includes detecting a touch interaction at 630, detecting a hover interaction at 640, identifying a combined touch and hover event at 640, and controlling an i/o interface at 650. However, method 600 also includes additional actions.

Conventionally, the appearance, operation, and other attributes of user actions may have been configurable through on-screen configuration. The configuration that was possible, if any, may have occurred through user interaction with the i/o interface and not through programmatic control. Additionally, since simultaneous touch actions and hover actions were not allowed, there was no configuration of simultaneous touch and hover actions. Example apparatus and methods provide a more configurable and extensible approach to configuration that supports simultaneous touch and hover actions. To support this configurability, method 600 may include, at 610, receiving an inbound message. The message may be received, for example, through an application programming interface (API) provided by a process running on the device. In different embodiments, the inbound message may also be received using other message passing approaches including, for example, sockets, remote procedure calls, interrupts, or shared memory. The inbound message may include configuration information that controls the type of combinations that will be accepted, how to parse multiple touches, how to parse multiple hovers, how to parse simultaneous actions, how to parse combinations of actions, time intervals for separate but related actions, callback addresses for event handlers, or other information. Method 600 may, as a function of receiving the inbound message at 610, selectively reconfigure which combinations are accepted and how the combinations are handled.

A user may interact with a touch-sensitive and hover-sensitive screen in different ways at different times. For example, at a first time a user may be using a texting application, at a second time a user may be editing a photograph, and at a third time a user may be handling their email. Different applications may have different types of interfaces with which a user may interact in different ways. A user may interact with their text application with their index finger, may interact with their email application with their thumbs, may interact with a video game with multiple digits, and may interact with a painting application with an electronic paint brush and multiple digits. User interfaces associated with virtual musical instruments may also employ multiple simultaneous touch and hover interactions. For example, a virtual violin may use a touch action to select a string to play and a hover action to simulate passing a bow over the string. The proximity of the hover action may control the volume of the instrument.

While FIGS. 5 and 6 illustrate various actions occurring in serial, it is to be appreciated that various actions illustrated in FIGS. 5 and 6 could occur substantially in parallel. By way of illustration, a first process could identify touch actions, a second process could identify hover actions, and a third process could process combined touch and hover actions. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 500 or 600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

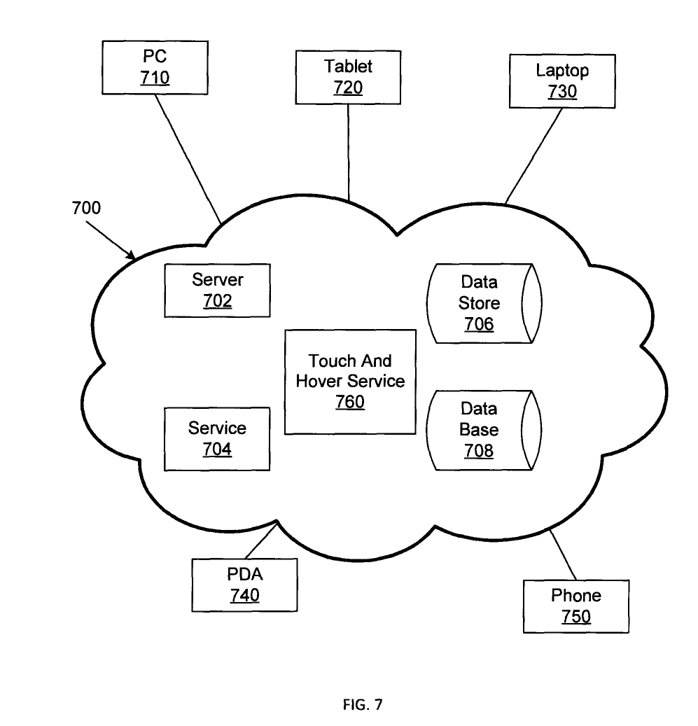

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example simultaneous touch and hover service 760 residing in the cloud. The simultaneous touch and hover service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the simultaneous touch and hover service 760.

FIG. 7 illustrates various devices accessing the simultaneous touch and hover service 760 in the cloud. The devices include a computer 710, a tablet 720, a laptop computer 730, a personal digital assistant 740, and a mobile device (e.g., cellular phone, satellite phone) 750. It is possible that different users at different locations using different devices may access the simultaneous touch and hover service 760 through different networks or interfaces. In one example, the simultaneous touch and hover service 760 may be accessed by a mobile device 750. In another example, portions of simultaneous touch and hover service 760 may reside on a mobile device 750. Simultaneous touch and hover service 760 may perform actions including, for example, configuring a touch and hover sensitive i/o interface, handling a callback for a combined touch and hover action, allowing a user to define a combined touch and hover action, or other service. In one embodiment, simultaneous touch and hover service 760 may perform portions of methods described herein (e.g., method 500, method 600).

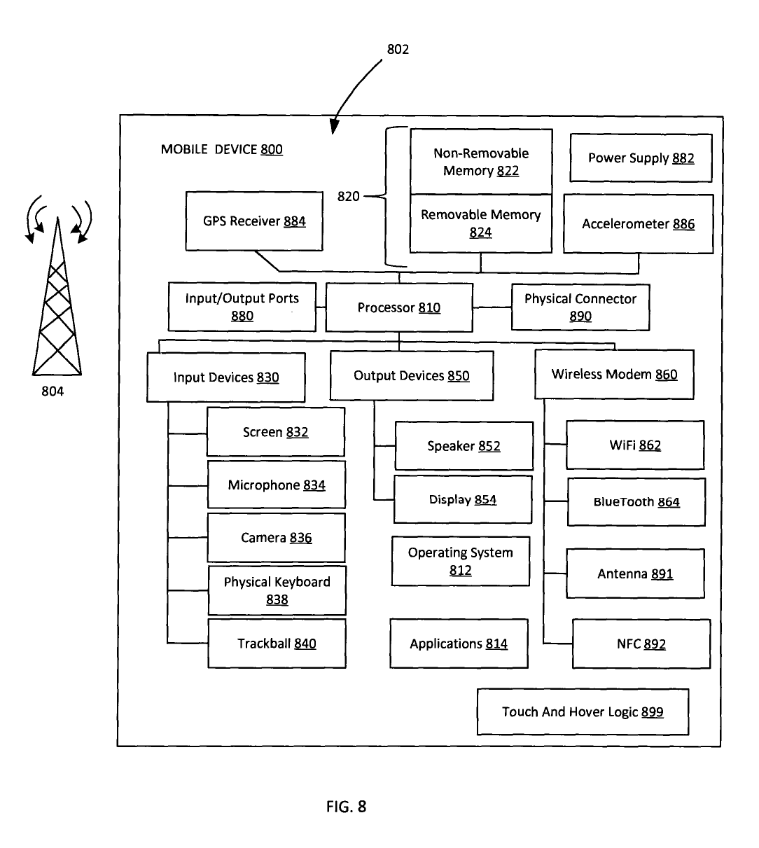

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), etc.) and may allow wireless two-way communications with one or more mobile communications networks 804, such as a cellular or satellite networks.

Mobile device 800 can include a controller or processor 810 (e.g., signal processor, microprocessor, application specific integrated circuit (ASIC), or other control and processing logic circuitry) for performing tasks including touch detection, hover detection, signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include touch action data, hover action data, combination touch and hover action data, user interface element state, web pages, text, images, sound files, video data, or other data sets to be sent to or received from one or more network servers or other devices via one or more wired or wireless networks. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a screen 832 that is both touch and hover sensitive, a microphone 834, a camera 836, a physical keyboard 838, or trackball 840. The mobile device 800 may also support output devices 850 including, but not limited to, a speaker 852 and a display 854. Display 854 may be incorporated into a touch-sensitive and hover-sensitive i/o interface. Other possible input devices (not shown) include accelerometers (e.g., one dimensional, two dimensional, three dimensional). Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting simultaneous touch and hover gestures to provide input to an application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a simultaneous touch and hover logic 899 that is configured to provide a functionality for the mobile device 800. For example, simultaneous touch and hover logic 899 may provide a client for interacting with a service (e.g., service 760, FIG. 7). Portions of the example methods described herein may be performed by simultaneous touch and hover logic 899. Similarly, simultaneous touch and hover logic 899 may implement portions of apparatus described herein.

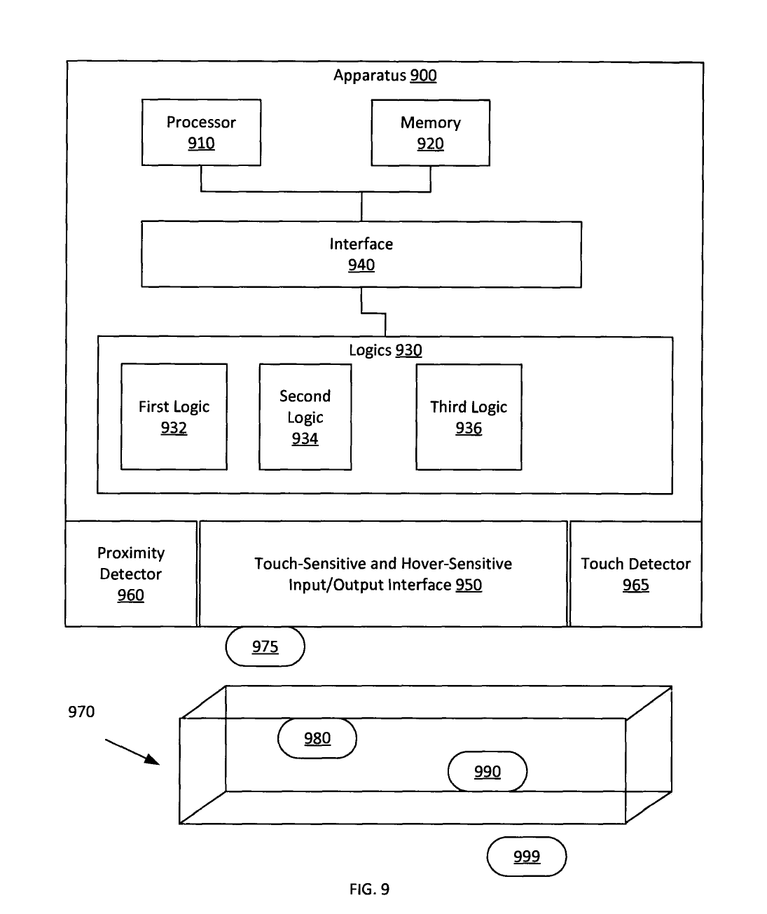

FIG. 9 illustrates an apparatus 900 that provides a simultaneous touch and hover interface. In one example, the apparatus 900 includes an interface 940 configured to connect a processor 910, a memory 920, a set of logics 930, a proximity detector 960, a touch detector 965, and a touch-sensitive and hover-sensitive i/o interface 950. In one embodiment, the proximity detector 960 and the touch detector 965 may share a set of capacitive sensing nodes that provide both touch-sensitivity and hover-sensitivity for the input/output interface. Elements of the apparatus 900 may be configured to communicate with each other, but not all connections have been shown for clarity of illustration.

The touch detector 965 may detect when an object 975 touches the i/o interface 950. The proximity detector 960 may detect an object 980 in a hover-space 970 associated with the apparatus 900. The hover-space 970 may be, for example, a three dimensional volume disposed in proximity to the i/o interface 950 and in an area accessible to the proximity detector 960. The hover-space 970 has finite bounds. Therefore the proximity detector 960 may not detect an object 999 that is positioned outside the hover-space 970.

Apparatus 900 may include a first logic 932 that is configured to produce characterization data concerning a simultaneous touch and hover event detected by the input/output interface. The characterization data may describe, for example, the location of a touch, the location of a hover, the time at which the touch occurred, the time at which the hover occurred, a direction in which the touch is moving, a direction in which the hover is moving, a gesture associated with the touch, a gesture associated with the hover, or other information. In one embodiment, the first logic 932 may produce the characterization data from signals associated with combined simultaneous touch and hover events. In another embodiment, the first logic 932 may produce the characterization data from signals associated with discrete touch and hover events.

Apparatus 900 may include a second logic 934 that is configured to control selectively receiving an input from the input/output interface or to control selectively providing an output to the input/output interface as a function of the combined touch and hover event. For example, a certain combination of touch and hover events may indicate that a certain input is to occur (e.g., add upper case E to text box) while another combination of touch and hover events may indicate that a certain output is to occur (e.g., play a sound from a virtual violin string, shoot virtual flames in a video game).

A combined touch and hover event may include a single touch portion and a single hover portion. In one embodiment, a touch portion of the touch and hover event controls a first attribute of a user interface element displayed on the input/output interface 950 and a hover portion of the touch and hover event controls a second attribute of the user interface element displayed on the i/o interface 950. For example, a touch portion may identify a location where an action is to occur and the hover portion may identify the action to occur at that location. In another example, a touch portion may identify an object to be controlled (e.g., virtual violin string) and the hover portion may identify an effect to apply to the string (e.g., bowing, plucking) and an intensity of the effect (e.g., volume control).

A combined touch and hover event may include multiple touch portions or multiple hover portions. In one action, a first touch portion may identify a location from which an effect (e.g., flames produced by magic spell) is to originate, a second touch portion may identify a direction in which the effect is to be applied, a first hover portion may identify a property of the effect (e.g., intensity) and a second hover portion may identify another property of the effect (e.g., degree to which the flames are to fan out). Different combinations of touch portions and hover portions can be used in different applications.

For example, the touch portion of the touch and hover event may include two or more touches on the input/output interface 950 or the hover portion of the touch and hover event may include two or more hovers in a hover-space associated with the input/output interface 950. The two or more touches and the two or more hovers may occur at least partially in parallel to produce a diverse, rich interaction with the device 900.

Apparatus 900 may include a third logic 936 that reconfigures how the second logic 934 processes the combined touch and hover event. The third logic 936 may reconfigure the second logic 934 in response to a message received from a user or an application through a messaging interface.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store user interface state information, characterization data, object data, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions. Processor 910 may be configured to interact with logics 930 that provide simultaneous touch and hover processing.

In one embodiment, the apparatus 900 may be a general purpose computer that has been transformed into a special purpose computer through the inclusion of the set of logics 930. The set of logics 930 may be configured to perform input and output. Apparatus 900 may interact with other apparatus, processes, and services through, for example, a computer network.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for interfacing with a device having an input/output interface that is both touch-sensitive and hover-sensitive, comprising:
detecting a touch interaction with the input/output interface;
detecting a hover interaction with the input/output interface, where the touch interaction and the hover interaction are related and operate at least partially simultaneously;
identifying a combined touch and hover interaction associated with the touch interaction and the hover interaction, and
selectively controlling the device as a function of the combined touch and hover interaction.

2. The method of claim 1, where detecting the touch interaction comprises receiving a first signal from a detector and where detecting the hover interaction comprises receiving a second signal from the detector.

3. The method of claim 1, where detecting the touch interaction and detecting the hover interaction comprises receiving a single signal from a detector.

4. The method of claim 1, where the touch interaction and the hover interaction are performed by the same object.

5. The method of claim 1, where the touch interaction and the hover interaction are performed by two separate objects.

6. The method of claim 1, where the touch interaction is two or more touch interactions, and where the two or more touch interactions occur serially or at least partially in parallel.

7. The method of claim 1, where the hover interaction is two or more hover interactions, and where the two or more hover interactions occur serially or at least partially in parallel.

8. The method of claim 6, where the hover interaction is two or more hover interactions, and where the two or more hover interactions occur serially or at least partially in parallel.

9. The method of claim 1, where selectively controlling the device as a function of the combined touch and hover interaction includes providing an input signal from the input/output interface.

10. The method of claim 1, where selectively controlling the device as a function of the combined touch and hover interaction includes providing an output signal to the input/output interface.

11. The method of claim 9, where selectively controlling the device as a function of the combined touch and hover interaction includes providing an output signal to the input/output interface.

12. The method of claim 1, where selectively controlling the device as a function of the combined touch and hover interaction includes controlling a typing application, controlling a video game, controlling a virtual painting application, or controlling a virtual musical instrument.

13. The method of claim 1, where the touch interaction controls a first attribute of a user interface element, where the hover interaction controls a second attribute of the user interface element, and where the combined touch and hover interaction coordinates controlling the first attribute and the second attribute simultaneously.

14. The method of claim 13, where the first attribute is a choice of a user interface element to display and the second attribute is a property of the user interface element.

15. A computer-readable storage medium storing computer-executable instructions that when executed by a computer cause the computer to perform a method for interfacing with an input/output interface that is both touch-sensitive and hover-sensitive, the method comprising:
detecting a touch interaction with the input/output interface, where the touch interaction is two or more touch interactions that occur serially or at least partially in parallel;
detecting a hover interaction with the input/output interface, where the hover interaction is two or more hover interactions that occur serially or at least partially in parallel, where the touch interaction and the hover interaction are related and operate at least partially simultaneously, where detecting the touch interaction and detecting the hover interaction comprises receiving a signal from a detector, and where the touch interaction and the hover interaction are performed by two separate objects;
identifying a combined touch and hover interaction associated with the touch interaction and the hover interaction, where the touch interaction controls a first attribute of a user interface element, where the hover interaction controls a second attribute of the user interface element, and where the combined touch and hover interaction coordinates controlling the first attribute and the second attribute simultaneously, and
selectively controlling the device as a function of the combined touch and hover interaction by providing an input signal from the input/output interface or by providing an output signal to the input/output interface.

16. An apparatus, comprising:
an input/output interface that is both touch-sensitive and hover-sensitive;
a first logic configured to produce characterization data concerning a simultaneous touch and hover event detected by the input/output interface; and
a second logic configured to control selectively receiving an input from the input/output interface or to control selectively providing an output to the input/output interface as a function of the combined touch and hover event.

17. The apparatus of claim 16, where the input/output interface includes a set of capacitive sensing nodes that provide both touch-sensitivity and hover-sensitivity for the input/output interface.

18. The apparatus of claim 17, where a touch portion of the touch and hover event controls a first attribute of a user interface element displayed on the input/output interface and where a hover portion of the touch and hover event controls a second attribute of the user interface element.

19. The apparatus of claim 18, where the touch portion of the touch and hover event comprises two or more touches on the input/output interface, where the hover portion of the touch and hover event comprises two or more hovers in a hover-space associated with the input/output interface, and where the two or more touches and the two or more hovers occur at least partially in parallel.

20. The apparatus of claim 19, comprising a third logic that reconfigures how the second logic processes the combined touch and hover event, where the third logic reconfigures the second logic in response to a message received from a user or an application through a messaging interface.
